(19) United States
(12) Patent Application Publication
(10) Pub. No.: US 2024/0010245 A1
(43) Pub. Date: Jan. 11, 2024

(54) ELEVATED PUBLIC TRANSPORTATION SYSTEM

(71) Applicant: Eitan ARON, Ramat Gan (IL)

(72) Inventor: Eitan ARON, Ramat Gan (IL)

(21) Appl. No.: 18/019,363

(22) PCT Filed: Jul. 29, 2021
(86) PCT No.: PCT/IL2021/050923

§ 371 Date: Feb. 2, 2023

Related U.S. Application Data
(60) Provisional application No. 63/061,321, filed on Aug. 5, 2020.

(51) Int. Cl. B61B 3/02

(52) U.S. Cl. CPC B61B 3/02

(57) ABSTRACT

Provided herein is an automated elevated public transportation system comprising an elevated railway network having a plurality of rails, configured to drive passengers and/or freight carts and drop off/pick up passengers and freight anywhere along the rails.

### FIELD OF THE INVENTION

Provided herein is an automated elevated public transportation system comprising an elevated railway network having a plurality of rails, configured to drive passengers and/or freight carts and drop off/pick up passengers and freight anywhere along the rails.

### BACKGROUND

Public transportation is an essential world-wide tool shaping social interactions, employment and educational opportunities, among other public dynamics, especially in urban areas. Pollution caused by individual modes of transportation and the rise of fuel cost led to continuous increase in the use of public transportation.

However, public transportation has its challenges and serious hurdles. Conventional bus service introduce issues of footprint, and together with convention rail system occupy valuable ground space. While the rail network of underground metropolitan railway may occupy little ground space, the stations associated therewith reside in large valuable areas. In fact, stations for uploading/downloading passengers is a common limitation of any kind of mass public transportation systems. Other disadvantages of underground metropolitan railway include the enormous budgets required for its construction and the massive technical/geographical hurdles that must be addressed.

U.S. Pat. No. 8,272,332 discloses a transportation system comprising an elevated track and descending tracks adapted to carry a cart to a ground level station for loading or unloading passengers.

U.S. Pat. No. 8,375,865 discloses a fully automated driverless personal transportation and freight delivery system consisting of vehicles riding on a pair of overhead parallel steel rails that form a single track and allows passengers to go anywhere along the tracks. Each vehicle has a steering mechanism and hence there no need for track switches to route vehicles to its destination. Rubber bumpers at each end of the propulsion dollies allow the vehicles to fit bumper-to-bumper along the single track.

WO 2012/167594 discloses a public transportation system with suspension-type monorail vehicles that includes rails, rail cars, a device for parking that comprises a stopping table associated with a channel, the stopping table is used for passengers entering or leaving the rail car, and the channel is connected to the ground through stairs or an elevator.

U.S. Pat. Nos. 10,473,478, 10,429,200 and 9,401,086 disclose computer products for estimating trip duration and traffic prediction and for creating dynamic traffic transportation plan map.

There is an unmet need for overhead public transportation for personal use, which is occupying little ground space and is not limited to predetermined upload/download stations.

### SUMMARY

There is provided an elevated public transportation delivery system, fully automated and driverless, adapted for personal use. The system comprises a network of elevated rails, the network comprises at least two separate tracks, each track is configured to transport at least one cart where passengers may go in or out of the system, anywhere along the route.

Advantageously, the elevated transportation system disclosed herein does not require, and is not associated with, predetermined station(s) allocated on the road or the sidewalk thereby occupies very little ground area. Moreover, it provides the passengers the ability to conveniently choose any pick-up and drop-off locations. Furthermore, each cart spends minimal time on ground, i.e., only during drop off/pick up of one or two passengers and further occupies very little ground area while being on the ground, since each cart includes relatively narrow and short passenger compartment designed to fit for one or two sitting passengers, and aside from the sits includes very little equipment.

Another benefit attributed to the elevated transportation system disclosed herein is that it poses minimal interference with the buildings along the route spread by the network system, since only one track is close to the sidewalk/curb and the building along the sidewalk. Namely, only the external lanes that also function as drop-off/pick-up lanes, are close to the curb. Moreover, the carts of the system are relatively small, having passenger compartments configured to include one or two passengers and hence each occupies small space (relative to a bus, a railway wagon and the like) thus forming little shade or hinder the view only for a several seconds, when passing during the day along the external rails. The remaining (inner) lanes are located away from the buildings and thus pose minimal to no interference with the view, the buildings and the events on the curb.

Furthermore, the system disclosed herein offers high safety measures, as detailed herein. For example, only one lane extends above, or relatively close to, sidewalks. In fact, since the passenger compartments are relatively small and narrow, the lane located next to the sidewalk, may be as narrow as a bicycle lane.

The system disclosed herein does not involve the formation of traffic jams. First, only one rail of the network functions also as a drop off/pick up lane, which enables the carts in the other lanes to continue driving. Thus, drop off/pick up of passengers does not create traffic jams, and does not require carts on other lanes to stop or even slow down. This structure also contributes to the safety of the system and its use since, it prevents, or at least reduces to minimum, collisions between carts. In addition, the driving of the carts along the system is automatically controlled by computing means, hence, driving along the system is devoid of traffic jams.

In addition to the above, the system disclosed herein is a ‘green’ system, providing superb sustainable transportation, optimal cost per value, as well as beneficial environmental, social and climate impacts, especially, in urban areas, at least due to the following properties: (a) no greenhouse gases are emitted and no carbon footprint is produced; (b) drive is quite; (c) at least some of the energy can be obtained from solar panels within the system (see, for example, FIG. 1C); (d) it is designed to be affordable to the public cost-wise (little energy consumption, fully automated and no need for drivers); (e) it is configured to reduce traffic congestion on the road; (f) it can be easily accessed (no need to walk to a station); (g) it uses less road space than private or public vehicles and less drop off/pick up space compared to bus/train stations; (h) the infrastructure of the system is flexible, namely, it can be easily installed without affecting the foundation of the road; (i) the system can be easily modulated—for example, adding/removing rails and changing travel direction do not require complicated operation; and (j) the flexibility and modularity of the system render its installation cost effective.

The above identified advantages are extremely valuable when using the system for freight transportation. Freight transportation via roads, using tracks and trains, has negative impacts, including, negative environmental effects (air pollution, noise, an indirect impart, such as, increasing greenhouse gases and global warming), vegetation and wildlife destruction and road accidents. Another major disadvantage of road transportation is the heavy burdens on traffic, especially, in urban and industrial areas, which are the main target of freights delivery. The system disclosed herein provides a cost per value, green, solution to freight delivery, as further detailed herein. Furthermore, since transportation along the system is fully automated and is devoid of traffic jams, delivery along the system is faster and without delays.

In some embodiments, there is provided an elevated public transportation system comprising:
(a) at least one interconnected rails network configured to transport carts in a travel direction there along, having a plurality of rails aligned with one another, wherein the plurality of rails comprising (i) an external sidewalk rail positioned at the periphery of the at least one interconnected rails network in proximity to a sidewalk, configured for picking up and dropping off passengers and/or freight, (ii) at least one additional rail, and (iii) at least one transition rail extended between the external sidewalk rail and the at least one additional rail, configured to enable transition of carts therebetween;
(b) at least one rotation assembly associated with the at least one interconnected rails network and configured to rotate a cart suspended from any of the rails in an angle; and

(c) a plurality of support posts configured to hold said at least one interconnected rails network above ground level.

In some embodiments, the elevated public transportation system further comprises at least one controller configured to control the operation of the elevated public transportation system and at least one power source configured to supply electricity to the elevated public transportation system.

In some embodiments, the elevated public transportation system further comprises at least one lifting assembly configured to hold, suspended therefrom, the cart, by extending between the cart and the at least one rotation assembly, wherein the lifting assembly is configured to lower down to ground level, and elevate to elevated level, the cart.

In some embodiments, the elevated public transportation system further comprises a plurality of carts, wherein each cart is configured to suspended from said plurality of rails of the at least one interconnected rails network through the at least one lifting assembly extending between the cart and the at least one rotation assembly, wherein the lifting assembly is configured to lower down to ground level, and elevate to elevated level, said each cart of the plurality of carts.

In some embodiments, the elevated public transportation system is not associated with predetermined drop off or pick up locations.

In some embodiments, the at least one power source configured to supply electricity to the elevated public transportation system through electric cables spread along the plurality of rails of the at least one interconnected rails network.

In some embodiments, the lifting assembly is configured to lower down to ground level, and elevate to elevated level said each cart of the plurality of carts, for dropping off and picking up one or more passengers and/or freight anywhere along the external sidewalk rail.

In some embodiments, the lifting assembly is configured to lower down to ground level, and elevate to elevated level said each cart, automatically, based on instructions received through the controller.

In some embodiments, the elevated public transportation system comprising a plurality of interconnected rails networks.

In some embodiments, the plurality of interconnected rails networks comprises two interconnected rail networks wherein one of the two interconnected rail network is configured to travel in the travel direction and the other interconnected rail network is configured to travel in a direction other than the travel direction.

In some embodiments, the two interconnected rail networks extend along two sides of the same track in substantially parallel directions, such that, one of the two interconnected rail network is configured to travel in the travel direction and the other interconnected rail network is configured to travel in the opposite direction.

The term “substantially parallel directions” as used herein includes parallel directions, such as, south to north direction and north to south direction, and also includes directions that are not absolutely parallel to one another by are more or less of opposite directions.

In some embodiments, the at least one additional rail is an external road rail aligned with external sidewalk rail, positioned farther way from the sidewalk.

In some embodiments, the rotation assembly is configured to rotate carts suspended from any of the rails in an angle of up to 270 degrees.

In some embodiments, the rotation assembly is configured to rotate carts suspended from any of external sidewalk rail and external road rail in said angle, towards the periphery of the at least one interconnected rails network.

In some embodiments, said each cart comprising at least one door facing the sidewalk.

In some embodiments, said each of the plurality of the support posts is arched, having one end pivoted in the ground and another end holding the plurality of interconnected rails elevated above ground level.

In some embodiments, the elevated public transportation system further comprises at least one internal rail positioned between the external sidewalk rail and the external road rail.

In some embodiments, the at least one controller controls the operation of the lifting assembly and the rotation assembly, based on (i) predetermined commands; (ii) real time commands received from passengers and potential passengers, wherein the commands comprise pick up locations and drop off destinations.

In some embodiments, said each cart is further configured to connect to a driving assembly extending between the lifting assembly and the rail from which the cart suspends, wherein the driving assembly comprises a plurality of wheels and engines configured to drive said cart along said rail, automatically.

In some embodiments, the at least one interconnected rails network comprises a rail housing configured to cover the interconnected rails network.

In some embodiments, the elevated public transportation system further comprising a plurality of solar panels, configured to provide power to said power source.

In some embodiments, the plurality of solar panels are attached to the rail housing.

In some embodiments, said each cart associates with an engine configured to maintain the cart in a position facing the travel direction, when said rotation assembly rotates the cart in said angle.

In some embodiments, the elevated public transportation system further comprising at least one junction, wherein at least two interconnected rail networks cross one another at the at least one junction.

In some embodiments, the at least one junction comprises at least one circular rail.

Other objects, features and advantages of the present invention will become clear from the following description, examples and drawings.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

### BRIEF DESCRIPTION OF THE DRAWINGS

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not to scale.

In the Figures:

FIGS. 1A-1G constitute a view in perspective of an elevated transportation system, according to some embodiments.

FIGS. 2A-2D constitute a view in perspective of a cart, according to some embodiments.

FIGS. 3A-3E constitute a view in perspective of a driving assembly, according to some embodiments.

FIGS. 4A-4E constitute a view in perspective of a rotation assembly, according to some embodiments.

FIGS. 5A-5J constitute a view in perspective of a lifting assembly, according to some embodiments.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure. In the figures, like reference numerals refer to like parts.

Throughout the figures of the drawings, different superscripts for the same reference numerals are used to denote different embodiments of the same elements. Embodiments of the disclosed devices and systems may include any combination of different embodiments of the same elements. Specifically, any reference to an element without a superscript may refer to any alternative embodiment of the same element denoted with a superscript. Components having the same reference number followed by different lowercase letters may be collectively referred to by the reference number alone. If a particular set of components is being discussed, a reference number without a following lowercase letter may be used to refer to the corresponding component in the set being discussed. In order to avoid undue clutter from having too many reference numbers and lead lines on a particular drawing, some components will be introduced via one or more drawings and not explicitly identified in every subsequent drawing that contains that component.

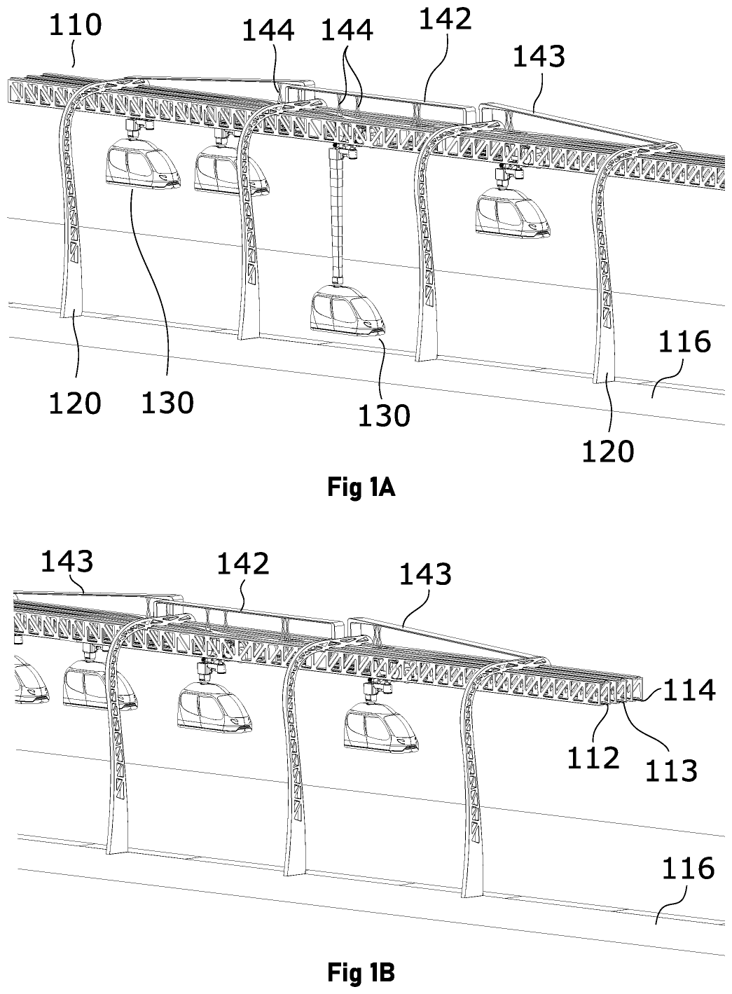

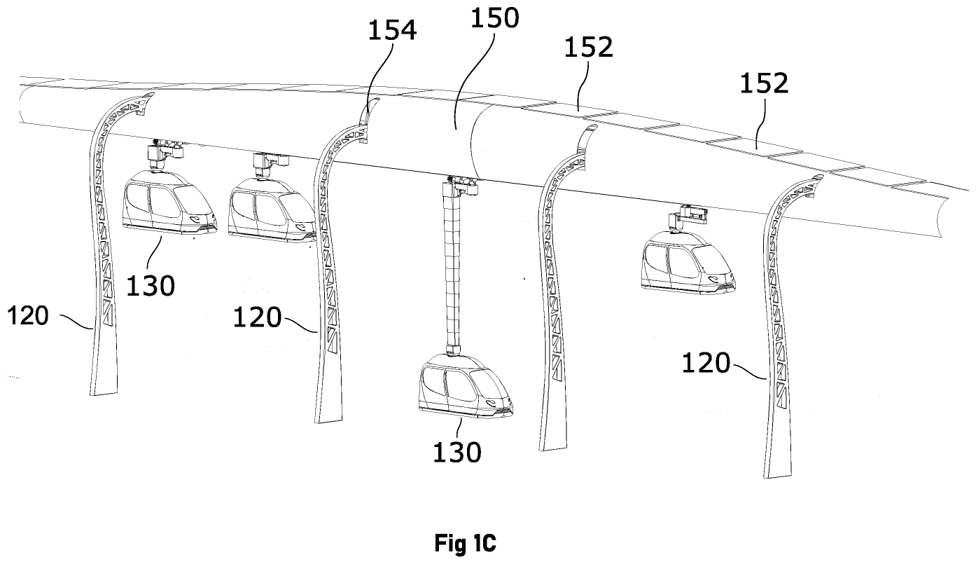

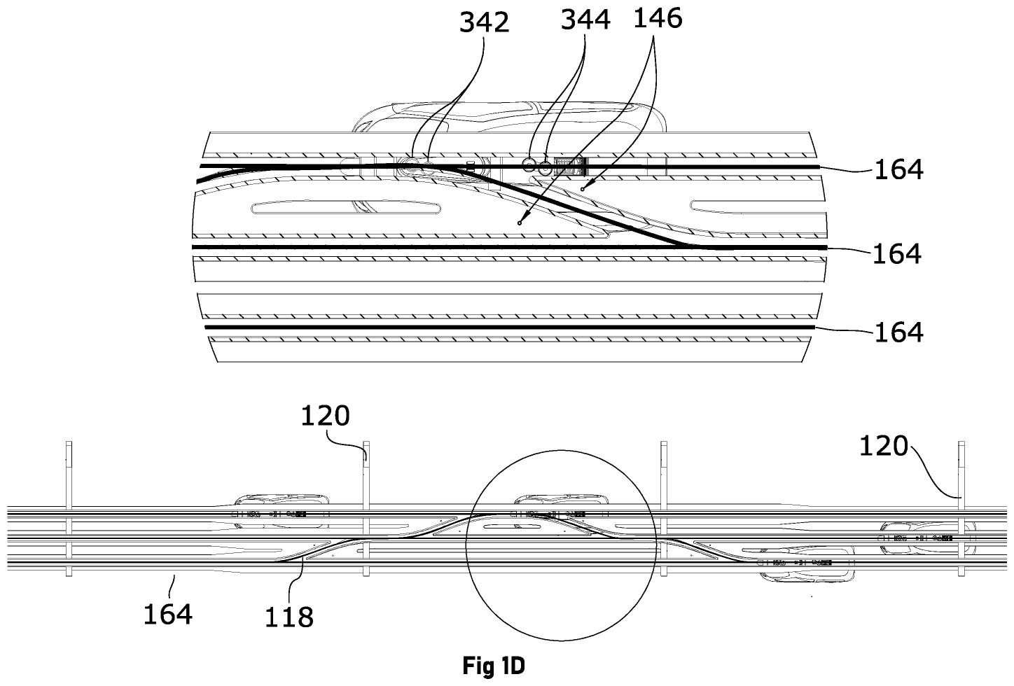

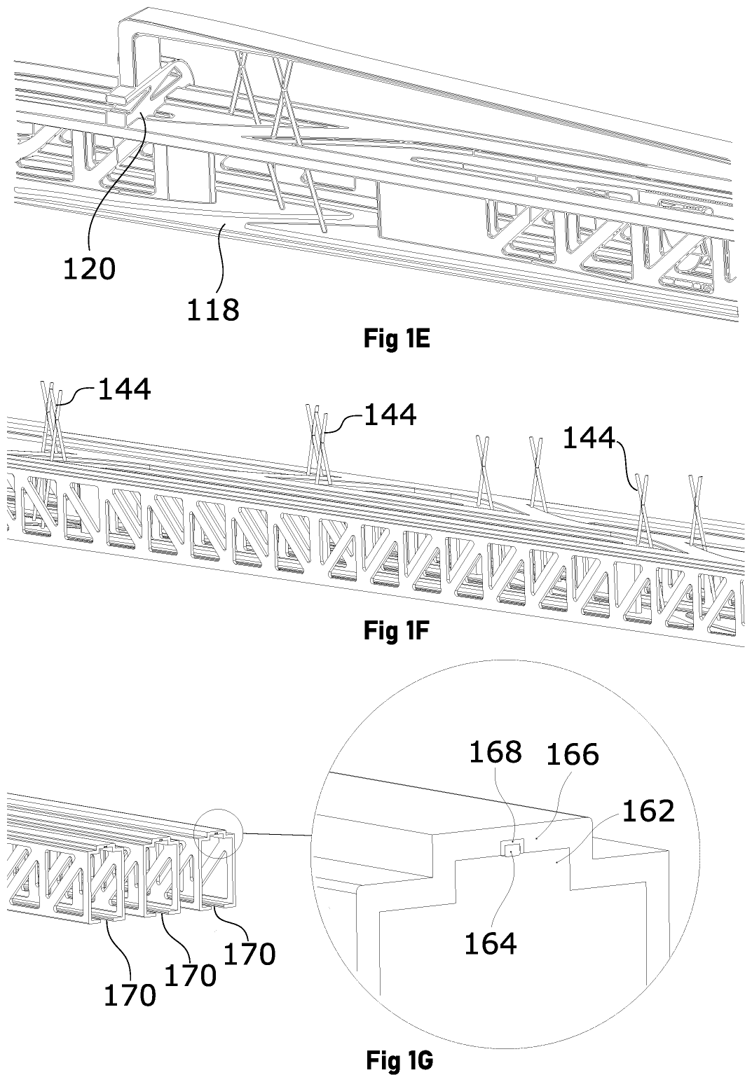

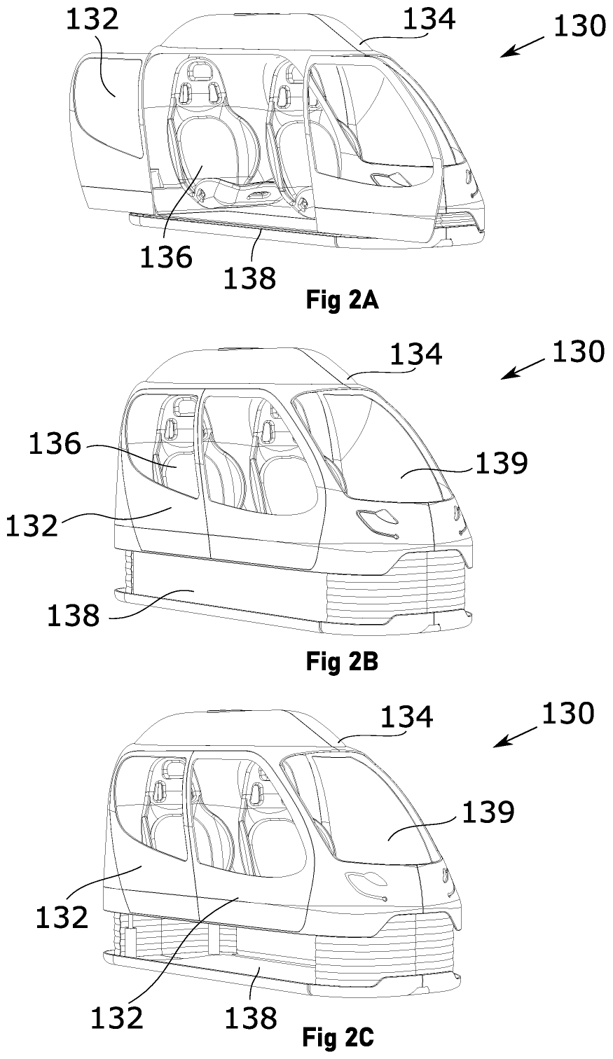

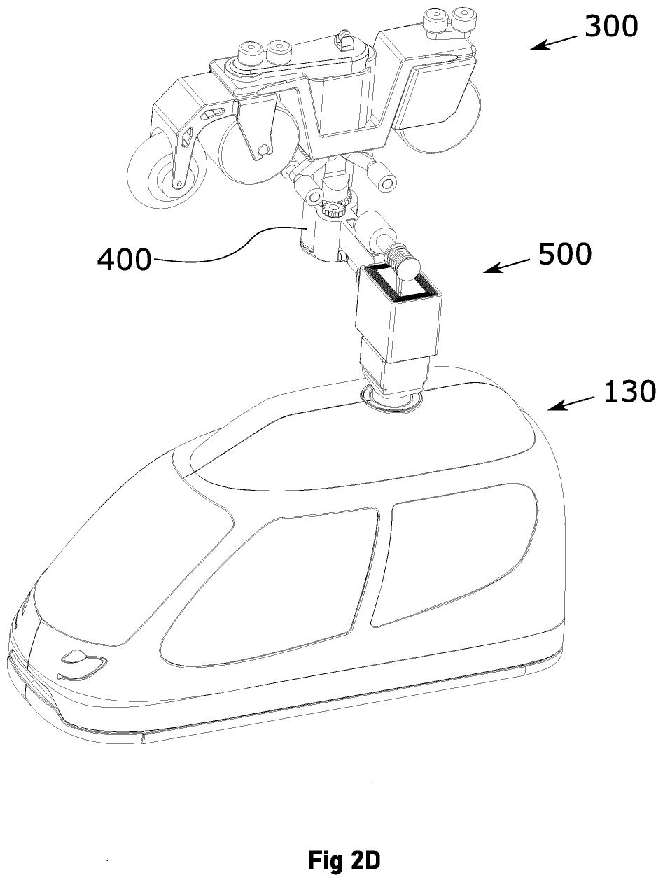

Reference is now made to FIGS. 1A-1G and 2A-2D. FIGS. 1A-1G constitute views in perspective of an elevated transportation system 100, according to some embodiments. Elevated transportation system 100 comprises interconnected rails network 110 comprising a plurality of rails. In some embodiments, interconnected rails network 110 comprises an external sidewalk rail 112 positioned at the periphery of interconnected rails network 110 in proximity to a sidewalk 116 and at least one additional rail.

The term plurality, as used herein, refers to more than one.

The term “sidewalk” as used herein is interchangeable with any one of the terms “footpath”, “pavement”, “curb” and “curbside”, and refers to a path, often on one or both sides of a road, which is car-free and is paved for pedestrians. In some embodiments, the term “sidewalk” is synonymous with the term ‘ground level’ or about ground level.

The term “proximity to the sidewalk” as used herein refers to location that is at the periphery of a sequence of interconnected rails adjacent to one another, and closest to the sidewalk, relative to the other rails (namely, relative to any one of internal rail 113 and external road rail 114).

As used herein, the term “about” may be used to specify a value of a quantity or parameter (e.g., length, distance, height) to within a continuous range of values in the neighborhood of (and including) a given (stated) value. According to some embodiments, “about” may specify the value of a parameter to be between 80% and 120% of the given value. For example, the statement “the distance is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

As used herein, according to some embodiments, the terms “substantially” and “about” may be interchangeable.

In some embodiments, external sidewalk rail 112 is configured to drive carts 130 along the rails in one direction and is further configured to drop off passenger(s) and/or freight to sidewalk 116 (ground level), or nearby sidewalk 116, and to pick up at least one passenger and/or freight from ground level.

In some embodiments, the at least one additional rail is an external road rail 114 configured to transport carts in the one direction, wherein external road rail 114 is aligned with external sidewalk rail 112, is closer to the center of the road above which interconnected rails network 110 suspends and is farther away from sidewalk 116.

The term “farther away” as used herein refers to any rail other than external sidewalk rail 112, which is not the closest rail to sidewalk 116, and hence is not used for downloading/uploading passengers. A rail that is farther away from sidewalk 116 may be adjacent to external sidewalk rail 112, yet it is farther away from sidewalk 116 relative to external sidewalk rail 112, since external sidewalk rail 112 is the closest rail to sidewalk 116 and hence it is the only rail from which carts 130 drop off/pick up passengers and/or freight.

The term “aligned”, as used herein, refers to symmetry planes of corresponding rails, namely, rails stretched along the same direction, e.g., the one direction, and hence are essentially along the same vertical plane. For example, external sidewalk rail 112 is aligned with external road rail 114 if their symmetry planes essentially correspond to vertical plane defining, or parallel to, a given direction (namely, the travel direction), such as, north to south, north to east, north to west, south to east, west to east, south to west or any other direction. Since perfect alignment is sometimes difficult to achieve, the term “essentially correspond” refers also to cases in which both symmetry planes are, at certain fragments along interconnected rails network 110 angled up to 10 degrees relative to each other. Intersection of rails in interconnected rails network 110 may be afforded, for example, through a transition rail 118, as shown in FIGS. 1E-1G.

In some embodiments, elevated transportation system 100 includes at least one junction, such as rail cross section 121 and circular rail 122, where two or more interconnected rails networks 110 change their travel direction.

In some embodiments, elevated transportation system 100 includes at least one circular rail 122 having a plurality of interconnected rails networks 110 merging therewith (not shown). In some embodiments, elevated transportation system 100 includes a plurality of circular rails 122, where each circular rail 122 having a plurality of interconnected rails networks 110 merging therewith. Upon integrating (merging) with circular rail 122, at least one rail of interconnected rails network 110 proceeds in a different direction relative to the direction the at least one rail came from. Close to the integration of one or more rails of interconnected rails network 110 into circular rail 122, interconnected rails network 110 includes a merging transition rail 118a which is configured to merge two rails of interconnected rails network 110 into one rail, wherein the one rail merges into circular rail 122.

In some embodiments, elevated transportation system 100 includes at least one rail cross-section 121 where two or more interconnected rails networks 110 cross one another, as shown in FIG. 1G.

At a junction, two or more interconnected rails networks 110 may merge together, thereby creating the ability of carts hanged from a given rail to merge with another rail and continue driving in a different direction. Alternatively, interconnected rail network 110 driving along direction A may change to any other direction, such as, direction B, via a junction, where direction A is different from direction B. In some embodiments, at least one rail from interconnected rail network 110 changes direction by merging with a junction, while the other rail(s) in interconnected rail network 110 do not merge with the junction.

It is noted that in case where interconnected rails network 110 includes two rails, then the two rails are external sidewalk rail 112 and external road rail 114. When interconnected rails network 110 includes more than two rails, then external sidewalk rail 112 and external road rail 114 are at the periphery of interconnected rails network 110 and the rest of the rails include one or more of an internal rail 113 positioned in between external sidewalk rail 112 and external road rail 114, and aligned therewith. Accordingly, external sidewalk rail 112 and external road rail 114 may be collectively referred as peripheral rails.

In some embodiments, interconnected rails network 110 further comprise at least one internal rail 113, wherein the at least one internal rail 113 aligns with external sidewalk rail 112 and external road rail 114 and is located in between these peripheral rails. In some embodiments, elevated transportation system 100 comprises a plurality of internal rails 113, wherein one internal rail 113 of the plurality internal rails 113 is adjacent to external sidewalk rail 112 and one internal rail 113 of the plurality internal rails 113 is adjacent to external road rail 114.

The term “adjacent” as used herein indicate that no other rails are stretched between two adjacent rails. Thus, adjacent may be synonymous with ‘neighboring’.

In some embodiments, the distance between adjacent rails is the minimum distance required for enabling two carts 130 associated with two adjacent rails to travel next to each other. The minimum distance thus depends on the width of carts 130. However, as explained below, each of cart 130 is linked to any of the rails though rotation assembly 400 (via driving assembly 300 and lifting assembly 500) which enables the rotation of cart 130 away from the plane between the ground and the rail, and towards the environment outside interconnected rail network 110. As a result, the actual distance between two adjacent rail may be smaller than a distance depending on the width of the carts.

The term “associated with” as used herein refers to a relation between two or more elements which does not require a direct connection therebetween. In some embodiments, the connection between elements associated with one another is through at least one additional element, wherein the at least one additional element is in direct connection with, or is connected to, at least one of said elements. In some embodiments, the terms “associated with” and “coupled to” are interchangeable.

In some embodiments, all rails of interconnected rails network 110 are substantially parallel to one another. In some embodiments, all rails of interconnected rails network 110 are sequentially arranged one next to another, such that, external sidewalk rail 112 is the rail in closest proximity to sidewalk 116, external road rail 114 is the rail in closest proximity to the center of the road over which interconnected rails network 110 suspends and is farthest away from sidewalk 116. In some embodiments, interconnected rails network 110 further includes at least one internal rail 113, which is positioned along, and in between, external sidewalk rail 112 and external road rail 114, such that, all rails of interconnected rails network 110, namely, external sidewalk rail 112, at least one internal rail 113 and external road rail 114 are sequentially arranged one next to another, between sidewalk 116 and the center of the road over which interconnected rails network 110 suspends.

Elevated public transportation system 100 further comprises at a: one cart 130 suspended from one of the rails in interconnected rails network 110.

The term “suspended” as used herein refers to the relationship between a cart 130 and a rail (112, 113, 114) from which it suspends, and is intended to describe that the cart is safely hanged from, otherwise held below or engaged to from below, said rail.

Elevated public transportation system 100 further comprises a plurality of support posts 120, configured to hold the plurality of interconnected rails 110, above ground level, at elevated position. In some embodiments, the height of elevated transportation system 100 above ground level is within the range of 3 to 8 meters. In some embodiments, the height of elevated transportation system 100 above ground level is at least 3 meters. In some embodiments, the height of elevated transportation system 100 above ground level is at least 3.5 meters. In some embodiments, the height of elevated transportation system 100 above ground level is at about 4 meters. In some embodiments, the height of elevated transportation system 100 above ground level is a height affording the passage of high vehicles, such as, trucks, underneath elevated transportation system 100. Accordingly, in some embodiments, the height of elevated transportation system 100 above ground level is about 4.5 meters. In some embodiments, the height of elevated transportation system 100 above ground level is within the range of 4.5 to 5.5 meters.

In some embodiments, the plurality of rails forming elevated transportation system 100 are not of the same height. For example, the height of external sidewalk rail 112 may be about 3.5 meters above ground level, while the height of the other rails, such as, internal rail 113 and/or external road rail 114, 112 may be about 4.5 meters above ground level.

Interconnected rails network 110 further comprises a plurality of transition rails 118 configured to enable transitions of cart 130 between any one of rails 112, 113 and 114. The plurality of transition rails 118 enables continuous flow of carts along the rails, wherein a congestion or slow-down events, hardly occur at interconnected rails network 110. Thus, the plurality of transition rails 118 enables easy and smooth ride, by directing carts 130 that do not require to be lowered to ground level, to internal rail(s) 113 and to external road rail 114, such that, the lowering down of cart 130 for dropping off or picking up, does not interfere with the ride of other carts traveling along interconnected rails network 110. In some embodiments, transition rail 118 branches out of any one of rails 112, 113 and 114 and stretches between any two adjacent rails, thereby enabling cart 130 to change between rails. In some embodiments, transition rail 118 stretches between any three adjacent rails. In some embodiments, transition rail 118 stretches between any number adjacent rails.

It is to be understood, that the number of the plurality of rails in elevated transportation system 100 is modular and is determined based on the traffic needs. Even after installation of the system, if/when traffic needs are changing, the number of rails may be modulated any time, to meet the new needs. Adding/reducing number of rails does not require re-installation of the system nor any fundamental changes. Specifically, modulating the number of rails does not involve changes in the infrastructure of the roads and streets above which the system is installed. Accordingly, modulating the number of rails does not requires much time nor high budgets. It is assumed that in quite areas, such as, suburban neighborhoods two rails may suffice. However, in busy areas, such as, the entrances to large metropolitans which may serve hundreds of cars at least during rush hours, more than three rails, more than four rails, and even more than five rails, may be required. As explained above, the initial number of rails may be changed at relatively low budget and without effecting the ground level.

In some embodiments, cart 130 changes between rails, through transition rail 118, automatically, based on commands received from a controller (not shown).

In some embodiments, interconnected rails network 110 has a uniform width throughout its length. In some embodiments, interconnected rails network 110 has a plurality of first portions each having a first width and a plurality of second portions each having a second width, wherein each first portion is a portion along the rails that is devoid of transition rails 118, and each second portion is a portion along the rails that includes transition rails 118, wherein the second width may be wider than the first width, as exemplified in FIG. 1D. In some embodiments, the difference in width between the first width and the second width is about 10%.

In some embodiments, elevated transportation system 100 further comprises rail support assembly configured to support interconnected rails network 110, in addition to the support provided by support posts 120. The rail support assembly is configured to support interconnected rails network 110 particularly, above and/or in the vicinity of transition rails 118, since each one of transition rails 118 branches from one of rails 112, 113 and 114, and at the branching area the continuity of the rail (112, 113 and 114) is disrupted. Although the disruption is minor and does not affect the stability and safety of elevated public transportation system 100, the rail support assembly is provided as an option for bolstering the stability and safety of elevated public transportation system 100. The rail support assembly may be any structure that can provide an additional support. In a non-limiting example, the rail support assembly includes planks and x-shaped supporting pillars, as shown in FIGS. 1A, 1B, 1E and 1F and further discussed below. It is to be understood, elevated transportation system 100 may include any number of support posts 120.

In some embodiments, the rail support assembly includes a plurality of planks 142, 143 each having a flat elongated surface and two ends, both ends are attached to the rail above which the plank is located. Some planks have a leg at each end, such that the flat, elongated surface of the plank, is configured to be parallel to the rail(s) above which it is positioned and to which it is attached, such as, plank 142. Other planks have one leg at one end, such that the flat, elongated surface thereof forms a sharp angle (less than 90 deg) with the rail(s) above which it is positioned and t which it is attached, such as, plank 143.

In some embodiments, plank 142 has at each end a leg perpendicular to the plane of the plank, creating a corner of about 90 degrees with the plank, where each leg extends between plank 142 and the rail parallel thereto. In some embodiments, plank 143 has a leg at one end thereof, such that plank 143 is connected to one or more rails (112, 113, 114) through the one leg extending therefrom on one end where the other end of plank 143 connects directly to the rail(s). Accordingly, the plane of plank 143 is not parallel to interconnected rail network 110, but rather creates a sharp angle (smaller than 90 degrees) with interconnected rail network 110. In some embodiments, each of planks 142, 143 is configured to be positioned above transition rails 118. In some embodiments, plank 142 is configured to be positioned at external portions of interconnected rail network 110, while plank 143 is configured to be connected at the ends of interconnected rail network 110. Thus, the rail support assembly is smartly designed to include relatively larger/heavier support, in the form of plane planks 142, in combination with lighter support (e.g., plank 143). This strategy reduces the overall weight of interconnected rail network 110 and is thus cost effective (reducing the overall amount of materials forming the network), while not compromising on safety. Thus, this strategy increase the overall cost per value of the elevated transportation system disclosed herein.

In some embodiments, the rail support assembly further includes a plurality of plank support pillars 144, configured to support planks 142, 143. Each plank support pillar 144 extends between interconnected rail network 110 to plank 142 or 143. In some embodiments, each plank 142, 143 is supported by at least one plank support pillar 144, having two ends, a bottom end attached to a rail and a top end attached to plank 142 or 143 above. In some embodiments, each plank 142, 143 is supported by at least one plank support pillar 144, having two ends, a bottom end attached to transition rail 118 and a top end attached to plank 142 or 143 above. In some embodiments, plank support pillar 144 has an x-shape, wherein the bottom end includes two legs planted opposite to one another from both sides of transition rail 118 and wherein each leg extends crosswise, relative to the other leg, to a plank (142 or 143) there above, as shown, for example in FIG. 1E. In some embodiments, the bottom end of plank support pillar 144 is placed within support pillar cavity 146. In some embodiments, transition rail 118 comprises a plurality of support pillar cavities 146, each configured to enclose the bottom end of plank support pillar 144.

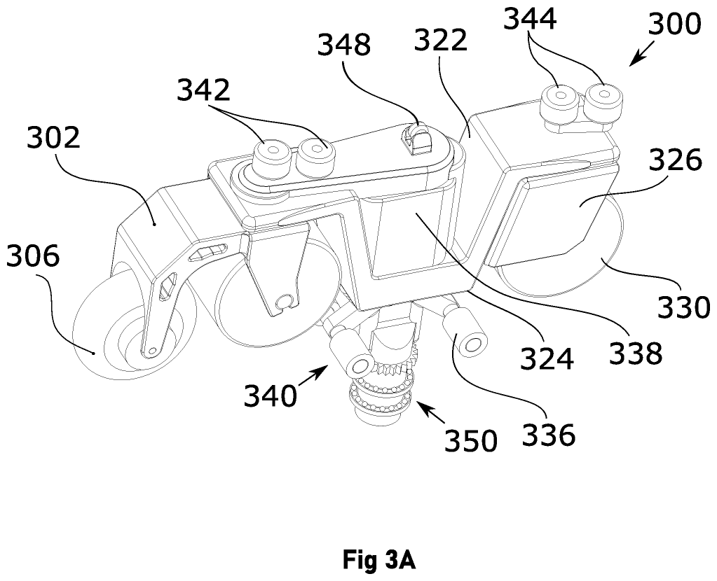

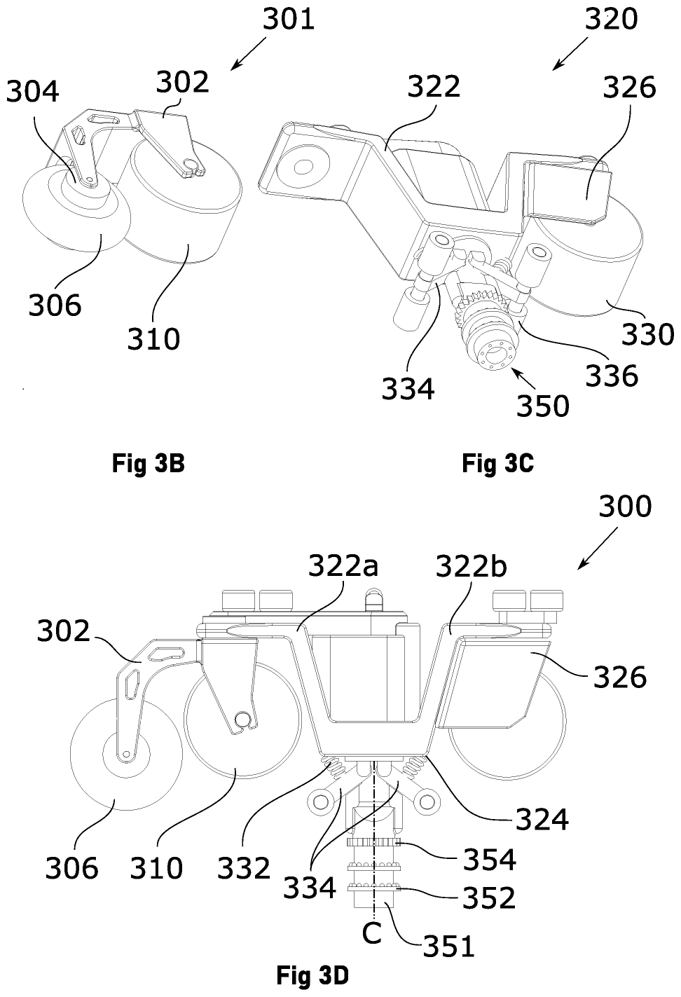

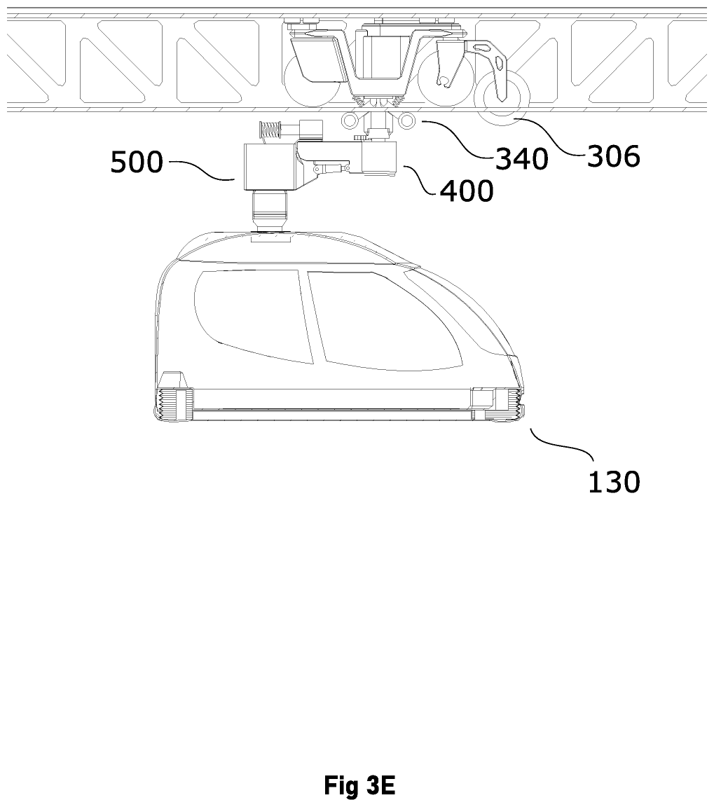

In some embodiments, each of the plurality of rails of interconnected rails network 110 includes a wheels recess 162, as can be seen in the rail cross-section, also termed herein “rail frame”, exhibited in FIG. 1G. Wheels recess 162 is configured to enclose front wheels 342 and back wheels 344, thus enable the progression of driving assembly 300 along the rail with minimal tilting (shown in FIG. 3A). In some embodiments, each of the plurality of rails of interconnected rails network 110 includes a power line recess 166 having its inner surface covered with an insulation layer 168, wherein power line recess 166 is configured to enclose a power line 164.

In some embodiments, each of the plurality of rails of interconnected rails network 110 includes outer leading wheel opening 170 configured to enable outer leading wheel 306 (shown in FIGS. 3A-3E) to lead the progression of driving assembly 300 along the rail with minimal tilting.

In some embodiments, elevated public transportation system 100 further comprises rail housing 150 configured to cover interconnected rails network 110, for protection and safety and noise reduction. The housing may protect the rails from rain, snow, hale, falling leaves, tree branches, birds, nests and the like. In some embodiments, rail housing 150 has a relatively flat top surface and side surfaces, such that, rail housing 150 encloses, or envelops, interconnected rails network 110. In some embodiments, rail housing 150 includes a plurality of slots, each for enabling access of support post 120 to interconnected rails network 110, thereby preventing interference between rail housing 150 and support posts 120. In some embodiments, rail housing 150 may be used to support a plurality of solar panels 152, which may be used to supply electric power to elevated public transportation system 100, and reduce, or even eliminate, the use of other power sources, thereby increase the sustainability of elevated public transportation system 100 and bolsters its beneficial impact on the environment. In some embodiments, rail housing 150 includes a plurality of solar panels 152 laid on, or attached to, the top surface of rail housing 150.

In some embodiments, elevated public transportation system 100 includes a plurality of floating solar panels 152a (not shown), wherein each floating solar panel 152a is attached to at least one pole extending from elevated public transportation system 100. In some embodiments, at least one floating solar panel 152a is attached to a rotating pole (not shown), wherein the rotating pole is capable of rotating in any angle. In some embodiments, the rotating pole is connected to an automatic sun tracking system, in order to obtain maximum intensity of sunlight throughout the day.

In some embodiments, public transportation system 100 is covered with plantation. In some embodiments, plants are planted in planters attached to the top (sky-facing) part of elevated public transportation system 100 or being planted in planters attached to rail housing 150. In some embodiments, plants are being planted on/over/within support posts 120.

In some embodiments, public transportation system 100 is a hybrid transportation system, obtaining its power from two or more distinct types of power and/or power sources. In some embodiments, public transportation system 100 is a hybrid transportation system, obtaining its power from two or more distinct types of power sources, wherein at least one power source is solar power, obtained thorough solar panels 152. The terms “each of” and “each of the plurality of”, as used herein, are interchangeable.

FIGS. 2A-2D constitute a view in perspective of a cart 130, according to some embodiments. In some embodiments, cart 130 comprises at least one door 132 configured for allowing passengers to enter and exit cart 130, when door 132 is open. In some embodiments, opening and closing of door 132 is controlled by a controller (not shown). In some embodiments, the opening and closing of door 132 is automated. For safety, the opening and closing of door 132 is automated and cannot be operated manually. In some embodiments, door 132 comprises an emergency opening setting (not shown) enabling passenger(s) within cart 130 to manually open door 132, in cases of emergency. In some embodiments, when cart 130 is elevated in case of emergency, the emergency opening setting may operate drive assembly 300 to transport cart 130 to external rail 112, if required (namely, if cart 130 is suspended from a rail other than external rail 112) and if afforded (namely, if the emergency event does not affect the operation of lift assembly) then operates lift assembly 500 to reduce cart 130 to ground level.

In some embodiments, cart 130 comprises at least one door 132 located on the sidewalk side of cart 130, also termed herein “driving side”, namely, the side close to sidewalk 116. For example, where driving is on the right side (e.g., U.S.), door(s) 132 are positioned only on the right side of cart 130, and where driving is on the left side, (e.g., UK) door(s) 132 are positioned only on the left side of cart 130. In some embodiments, the side opposite to the driving side of cart 130, also termed roadside (not shown) is devoid of door 132. In some embodiments, the side opposite to the driving side of cart 130 may include an emergency exit (not shown) which can be operated only by emergency opening setting. In some embodiments, door 132 has a window. In some embodiments, cart 130 further includes a front window 139 configured to face the driving direction.

In some embodiments, cart 130 further comprises a user interface (not shown) connected to the controller, enabling communication between passenger(s) in cart 130 and the controller. The user interface may indicate the Estimated Time of Arrival (ETA), by announcing it and/or though notification on its screen. Passenger(s) may use the user interface to view map and/or schedule of elevated public transportation system 100. The user interface may enable passengers to change destination, any time. The user interface may further allow communication between passengers using, or travelling on, elevated public transportation system 100. For example, passengers travelling on different cart 130 to different destination, may change their destination, though user the user interface, in order to get off at the same location.

In some embodiments, cart 130 further includes at least one sensor (not shown) configured to detect items under cart 130 when it is reduced to ground level. The at least one sensor is in communication with the controller, wherein lowering down cart 130 to ground level is enabled when the at least one sensor does not detect any item under cart 130. In the event that the at least one sensor detects an item (e.g. a pedestrian, a vehicle, such as, a bicycle, and/or a pet) a signal is sent to the controller, accordingly the controller may postpone or halt the lowering of cart 130 and re-initiate it when the space under cart 130 is clear, or may induce propagation of cart 130 a short distance ahead (e.g. a few meters), to area at ground level that is clear of items and is safe for landing cart 130.

Any suitable mechanism of door opening/closing may be applied for opening/closing door 132. In some embodiments, door 132 operates through sliding along a rail attached to cart 130 as exemplified in FIG. 2A.

In some embodiments, cart 130 further comprises a freight storage space 138. In some embodiments, freight storage space 138 is located at the bottom of cart 130. In some embodiments, freight storage space 138 is located at the back of cart 130. In some embodiments, freight storage space is located at the top of cart 130. In some embodiments, freight storage space 138 is located under each passenger seat 136.

In some embodiments, freight storage space 138 is located in the bottom of cart 130 in a compressed form as exemplified in FIG. 2A, when not in use, and is configured to expand, when required, as exemplified in FIGS. 2B and 2C. In some embodiments, freight storage can be locked, as exemplified in FIG. 2B, when in an expanded form.

In some embodiments, for uploading freight into storage space 138, cart 130 is lowered to an uploading height, namely, a height above ground level that is comfortable for uploading freight, for example, a height within the range of about 80 cm to about 150 cm, above ground level. Upon approaching the uploading height, storage space 138 may open up either automatically, or by a user (e.g., by pressing on a suitable bottom (not show) or by sending instructions through user's device (e.g., smart phone, iPad)). Instructions may be sent via an application corresponding to elevated public transportation system 100. Upon uploading freight into storage space 138, cart 130 lower down to ground level, enabling passengers to easily enter and sit within cart 130.

In some embodiments, cart 130 may include a ramp (not shown), for example, a wheelchair ramp. In some embodiments, each passenger seat 136 may include a ramp that opens up when required. The ramp is configured to permit wheelchair users, and passengers pushing strollers, carts, or other wheeled objects, to access cart 130 more easily. In some embodiments, the ramp associated with seat 136 may open up to enable wheeled objects to access cart 130, or may open up enabling seat 136 to slide down to the pavement, to enable easy access thereto, and once a passenger sits on seat 136 the ramp is configured to elevate seat 136 back into cart 130.

Through the application corresponding to elevated public transportation system 100 users may order to be picked up by elevated public transportation system 100 at any desired locations and times, may update their destination, view a map showing where elevated public transportation system 100 spreads, update whether or not freight is included (which requires opening of freight storage space 138, and lowering cart 130 to the uploading height for uploading the freight), among other operations. In some embodiments, elevated public transportation system 100 does not require uploading on the application associated therewith the destination, when ordering a trip. Accordingly, a passenger using elevated public transportation system 100 may inform the system of destination during the trip, either via an application on user's personal device, or by calling a call center related to elevated public transportation system 100, or via the user interface installed in cart 130.

In some embodiments, cart 130 is connected, directly or indirectly, through its top surface 134 to several assemblies, including, a driving assembly, a rotation assembly and a lifting assembly.

Driving assembly is the mechanism that operates transportation of carts, such as, cart 130 along each of the plurality of the rails in interconnected rail network 110. To this end, any driving assembly may be used.

In some embodiments, the driving assembly is driving assembly 300 as shown in FIG. 2D and further discussed below.

In some embodiments, the rotation assembly is rotation assembly 400 as shown in FIG. 2D and further discussed below.

The lifting assembly is configured to lower cart 130 to ground level and lift it to elevated level, in a continuous smooth and safe manner. In some embodiments, the lifting assembly is lifting assembly 500, as shown in FIG. 2D and further discussed below. In some embodiments, the lifting assembly is lowering and lifting the cart associated therewith automatically. In some embodiments, the lifting assembly is lowering and lifting the cart associated therewith manually, e.g., by pressing on a suitable bottom (not shown) or by sending instructions through user's device (e.g., smart phone, iPad). The manual option can become useful under certain conditions, such as, but not limited to, in case of emergency where immediate operation is required, without depending on the automatic system, in case the automatic system fails or is under a cyber-attack, and so on.

It is to be understood that for any automatic operation of the public transportation system disclosed herein there is a corresponding manual operation, which can be used in particular cases, such as, under emergency and/or when the automatic operation should not, or cannot be, applied.

In some embodiments, elevated public transportation system 100 comprises a plurality of interconnected rail networks 110. In some embodiments, each of the plurality of interconnected rail networks 110 is extending along a different route, such that, one interconnected rail network 110 is extending along one route, another interconnected rail network 110 is extending along a second route, and so on. In some embodiments, the plurality of interconnected rail networks 110 comprises two interconnected rail network 110 extending along two sides of the same track (e.g. street(s), road(s)) in parallel directions, such that, one of the two interconnected rail network 110 is configured to travel in one direction (e.g. heading north, and travelling from south to north) and the other interconnected rail network 110 is configured to travel in a direction opposite to the one direction (e.g. heading south, and travelling from north to south). In some embodiments, the plurality of interconnected rail networks 110 comprises at least one interconnected rail network 110 extending in a direction that is substantially perpendicular (e.g., heading east) to the direction of at least one other interconnected rail network 110 (e.g., heading north).

The term “track” as used herein intends to define the same route, or course of travel of interconnected network 110. The track may be a road, and may include a plurality of roads, along which interconnected network 110 extends and configured to transport carts 130 and passengers.

Reference is now made to FIGS. 3A-3E which constitute several perspective views of a driving assembly 300, according to some embodiments. Driving assembly 300 is the mechanism that operates transportation of cart 130 along each of the plurality of the rails in interconnected rail network 110. Driving assembly 300 includes safety features, as detailed below, which prevent undesired movements of cart 130 enabling the passengers to experience smooth and pleasant travel along elevated public transportation system 100.

In some embodiments, driving assembly 300 comprises a leading system 301 configured to lead driving assembly 300 along any one of rails 112, 113 and 114. Leading system 301 comprises a leading wheel arm 302 having two ends, one end configured to connect leading system 301 to driving support system 320 and another end configured to hold a set of driving wheels having a central leading wheel 304 and an outer leading wheel 306 connected to one another, centrically, and held by wheel arm 302 through wheel axel 308. In some embodiments, central leading wheel 304 is configured to remain within the rail frame, while outer leading wheel 306 projects out of the rail frame, through leading wheel opening 170, as exemplified in FIGS. 1G and 3E. This configuration prevents undesired/tilt movements of driving assembly 300, and hence of cart 130 connected thereto, to the sides (right and left, namely, prevents movement in an axis that is perpendicular to the travel direction). Accordingly, the configuration of leading system 301 contributes to the stability of cart 130, during its transportation along the rail (112, 113, 114) from which it suspends and also operates as a steering wheel which leads the propagation of cart 130 along the rails, in the desired direction.

In some embodiments, driving assembly 300 further comprises a steering wheel/navigation system (e.g., engine) maintained within housing 338 and electrically connected to leading system 301, where this system is configured to navigate leading system 301, and/or perform as a steering wheel enabling side (left/right) adjustments/movements of leading system 301, as may be required during the driving course of cart 130 along the rail from which it suspends.

Leading system 301 further comprises main front wheel 310 and main back wheel 330. In some embodiments, at least one of main front wheel 310 and main back wheel 330 includes a driving engine (not shown) which is configured to drive forward, along the rail within which driving assembly 300 (and cart(s) 130 hanging therefrom, and attached to driving assembly 300) is positioned.

In some embodiments, main front wheel 310 includes a driving engine. In some embodiments, main back wheel 330 includes a driving engine. In some embodiments, each of main front wheel 310 and main back wheel 330 includes a driving engine

In some embodiments, main back wheel 330 is connected to wheel frame 322 through connecting element 326, and is configured to drive in the travel direction following the propagation of main front wheel 310.

In some embodiments, driving assembly 300 is operating by electricity received from power line(s) 166 through an electric component 348. In some embodiments, the navigating system (e.g., engine) maintained within housing 338 and the driving engine(s) obtain electric powers from electric component 348.

While the illustrated leading wheel arm 302 is having a corner shape, leading wheel arm 302 may have an alternative shape, e.g., it may be linear. Additionally, leading wheel arm 302 need not be a single piece as shown, for example, in FIGS. 3A, 3B, 3D. Instead, leading wheel arm 302 may be formed by attaching multiple individual parts, which together hold central leading wheel 304 and outer leading wheel 306, such that, together they operate to prevent movement of driving assembly 300 in undesired directions, and particularly, in an axis perpendicular to the travel direction.

In some embodiments, driving assembly 300 comprises a driving support system 320, which includes a wheel frame 322. Wheel frame 322 is configured to support the component of driving assembly 300. In some embodiments, wheel frame 322 is having a u-shape structure with a lower base 324 and two side arms 322a, 322b, extending from the top ends of the u-shape.

In some embodiments, wheel frame 322 includes a pair of upper front wheels 342 and a pair of upper back wheels 344. Upper front and back wheels 342, 344 are configured to travel in recess 166 of the rail on which driving assembly 300 is mounted, thereby provide further support to driving assembly 300 and cart 130 hanging therefrom, by preventing from driving assembly 300, and hence cart 130, from tilting sidewise right/left within the rail. It should be noted that any minor tilt at the rail may be translated to a large, disturbing, tilt of cart 130, especially when cart 130 is at ground level. Thus, the set of upper front and back wheels 342, 344 provide yet another significant contribution to the safety and stability of elevated public transportation system 100, and also contributes to a pleasant riding experience, with minimum undesired movements other than traveling in the travel direction.

The term “corresponding”, as used herein to describe a relationship between one of a plurality of components and one of the plurality of other components, namely, it refers to a specific component from the plurality of components, which is aligned with, connected to, associated with, held by, operates with, the specific other component from the plurality of other components.

In some embodiments, driving support system 320 further comprises a tightening complex 340 attached to lower base 324 of wheel frame 322, configured to stay under the rail frame of the rail on which driving assembly 300 is mounted, in order to maintain driving assembly 300 in tight contact with said rail. During travelling along the rails, the topography of the road may change and as a result the distance (height) between interconnected rails network 110 and the ground may vary. Such variations may affect the attachment between driving assembly 300 and the rail on which it is mounted. Advantageously, tightening complex 340 provides some flexibility to driving assembly 300 and prevents excess pressure thereon, that may be induced by road topography. Thus, tightening complex 340 provides an additional contribution to the safety and durability of elevated public transportation system 100. In some embodiments, tightening complex 340 includes a pair of springs 332 each extending from wheel frame 322 to a leg of a T-shaped member 334, wherein each arm of T-shaped member 334 holds a tightening wheel 336.

Driving assembly 300 further includes a cart holder 350, configured to attach cart 130 to driving assembly 300, through binding to driving support system 320. Cart holder 350 is further configured to enable rotation of cart 130 around axis C. In some embodiments, cart holder 350 obtains power from and engine housed in housing 338

In some embodiments, cart holder 350 includes a cart holder shaft 351 and further includes components that enable to transmit rotary motion and power to cart 130. Such components include, but are not limited to, gears, pulleys and sprockets and corresponding mating gears, belts and chains. In some embodiments, cart holder shaft 351 includes one or more bearing members, such as, bearing 352. In some embodiments, cart holder shaft 351 includes one or more sprockets, such as, sprocket 354.

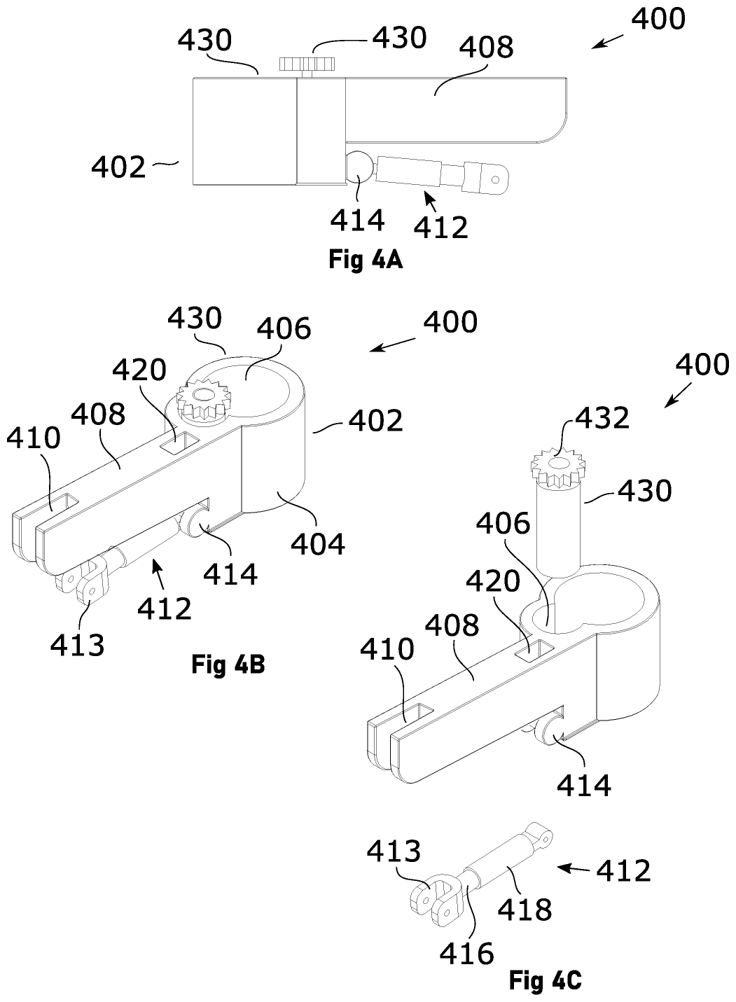

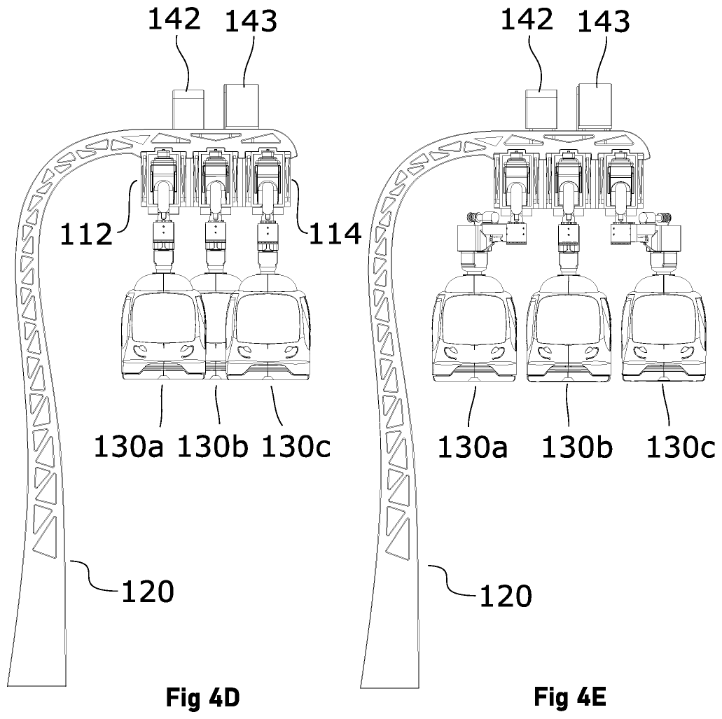

Reference is now made to FIGS. 4A-4C and FIGS. 4D-4E which constitute several perspective views of a rotation assembly 400, and elevated public transportation system 100, respectively, according to some embodiments. Rotation assembly 400 is configured to enable rotation of cart 130 suspended from any of the peripheral rails, namely, external sidewalk rail 112 or external road rail 114. In some embodiments, rotation assembly 400 is configured to enable rotation of cart 130 in any angle. In some embodiments, rotation assembly 400 is configured to enable rotation of cart 130 in an angle of no more than 270 degrees. In some embodiments, rotation assembly 400 is configured to enable rotation of cart 130 in an angle within the range of 25 to 180 degrees. In some embodiments, rotation assembly 400 is configured to enable rotation of cart 130 in an angle of no more than 180 degrees. In some embodiments, rotation assembly 400 is configured to enable rotation of cart 130 in an angle of no more than 270 degrees. In some embodiments, rotation assembly 400 is configured to enable rotation of cart 130 in an angle within the range of 50 to 150 degrees. In some embodiments, rotation assembly 400 is configured to enable rotation of cart 130 in an angle within the range of 70 to 120 degrees. In some embodiments, rotation assembly 400 is configured to enable rotation of cart 130 in an angle within the range of 80 to 110 degrees. By this rotation, cart 130 turns away from its position, in an angle within the range of 80 to 110 degrees, while the cart front window 139 of cart 130 remains to face the travel direction. The rotation is toward the periphery of interconnected rails network 110. FIGS. 4D and 4E demonstrate carts 130a, 130b, 130c suspended from three adjacent rails, wherein cart 130a suspended from external sidewalk rail 112 can rotate from being right below external sidewalk rail 112, as shown in FIG. 4D, towards sidewalk 116, as shown in FIG. 4E. Similarly, cart 130c suspended from external road rail 114 can rotate from being right below external road rail 114 toward the center of the road (the road above which interconnected rails network 110 suspends), as shown in FIGS. 4D and 4E, respectively. Thus, carts 130a and 130c rotate in opposite directions, as a result a space is formed between carts 130a and 130c enabling cart 130b, suspending from internal rail 113, to move forward and drive, or stay next to carts 130a and 130c, or pass carts 130a and 130b. Thus, rotation assembly 400 offers a smart mechanism that enables carts along interconnected rail network 110 to pass a slowing down cart, without exchanging rails. This mechanism may be typically useful for carts traveling in the vicinity of a cart suspending from external sidewalk rail 112 when the carts has to slow down and eventually stop and descend to ground level, in order to drop off/pick up passengers/freight.

In some embodiments, rotation assembly 400 is configured to enable rotation of cart 130 prior to descending to ground level, thereby bringing cart 130 closer to the curb. This mechanism enables to construct elevated public transportation system 100, or parts thereof, above the road, where rotation assembly 400 brings a cart hanging from external sidewalk rail 112 to, or closer to, the curb when picking up, or dropping off, passengers and/or freight.

In some embodiments, rotation assembly 400 is configured to enable rotation of cart 130 suspended from any of the peripheral rails in an angle. In some embodiments, the angle is within the range of 0 to 360 degrees. In some embodiments, the angle is up to 270 degrees, up to 180 degrees or up to 120 degrees. Each possibility is a separate embodiment of the present invention. In some embodiments, the angle is within the range of 60 to 150 degrees. In some embodiments, the angle is within the range of 60 to 120 degrees. In some embodiments, the angle is within the range of 70 to 110 degrees. In some embodiments, the angle is within the range of 80 to 100 degrees. In some embodiments, the angle is within the range of 85 to 95 degrees. In some embodiments, rotation assembly 400 is configured to enable rotation of cart 130 suspended from any of the peripheral rails in an angle of about 90 degrees.

It is to be understood that through the application of rotation assembly 400 the effective width for carts, spread on an interconnected rails network 110, is wider than the width of the rails on an interconnected rails network 110. Thus, rotation assembly 400 provides the system an ability to spread broadly, while the plurality of rails in interconnected rails network 110 maintain relatively narrow width (due to the narrow size of the carts).

In some embodiments, rotation assembly 400 includes a rotation member 402 configured to extend from driving assembly 300 to lifting assembly 500, and thus to operate as a linking component, linking driving assembly 300 positioned in, and within, interconnected rails network 110 to lifting assembly 500 which is connected directly to cart 130, as shown in FIG. 2D. Thus, rotation assembly 400 associates driving assembly 300 and interconnected rails network 110 with cart 130, through cart holder 350. In some embodiments, rotation member 402 is having a first portion configured to connect to driving assembly 300, said portion is having a cart holder bushing 404 configured to house therein cart holder 350. In some embodiments, rotation member 402 further includes a rotation motor bushing 406 configured to include therein a rotation motor housed within rotation motor sleeve 430. In some embodiments, cart holder bushing 404 and rotation motor bushing 406 form together one slot combining same. In some embodiments, cart holder bushing 404 and rotation motor bushing 406 are separated from one another. Advantageously, by combining bushings 404 and 406 into one combined slot, less material is involved in the configuration of elevated public transportation system 100, and particularly of rotation assembly 400 which may render it lighter and less complicated.

The rotation motor (not shown) is configured to allow rotation of rotation assembly 400, and thereby of cart 130 relative to the driving direction, as shown for example in FIG. 4E, in which each of carts 130a and 130c are rotated away from cart 130b, by about 90 degrees. Limiting the rotation to about 100 degrees may be afforded by a limiting component, such as, a rotation shaft sprocket 432. Thus, the rotation motor is an additional safety component, as it prevents random, uncontrollable, rotation of cart 130. Moreover, together with rotation shaft sprocket 432, the rotation motor prevents rotation beyond a desired limit of about 100 degrees.

In some embodiments, rotation member 402 further includes a second portion configured to connect to lifting assembly 500, said second portion is having a rotation arm 408 extending from the first portion towards lifting assembly 500 and ending with a u-shaped end 410, configured to attach to lifting assembly 500 through a lifting assembly connector 520.

In some embodiments, rotation assembly 400 further includes shock absorbing arm 412 connected to rotation member 402, through hinge 414, configured to act as a shock absorber, by absorbing some of the energy produced during transportation or movements (e.g., due to winds) of cart 130. Thus, shock absorbing arm 412 is configured to prevent, or reduce, back and forth tilting movements of cart 130, when on a brake, and/or configured to prevent undesired shifts backward/forward while riding along any of the rails in the travel direction. In some embodiments, shock absorbing arm 412 operates through hydraulic mechanism. In some embodiments, shock absorbing arm 412 operates through pneumatic mechanism. For example, shock absorbing arm 412 may include an inner brake shaft 416 telescopically movable within brake shaft outer member 418. The mechanism by which shock absorbing arm 412 operates absorbs the excess pressure formed by the excess energy and hence softens, or even prevents, pendulum motions. Thus, shock absorbing arm 412 is an additional safety mechanism that advantageously impacts the stability, security and durability of elevated public transportation system 100.

In some embodiments, shock absorbing arm 412 includes a clevis 413 configured to attach to lifting assembly 500 through a lifting assembly connector 520.

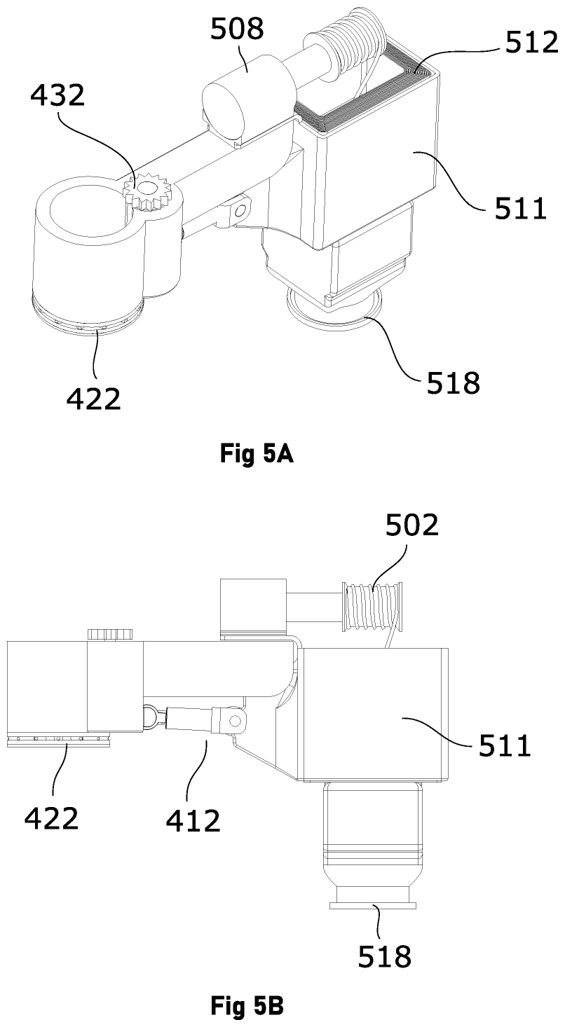

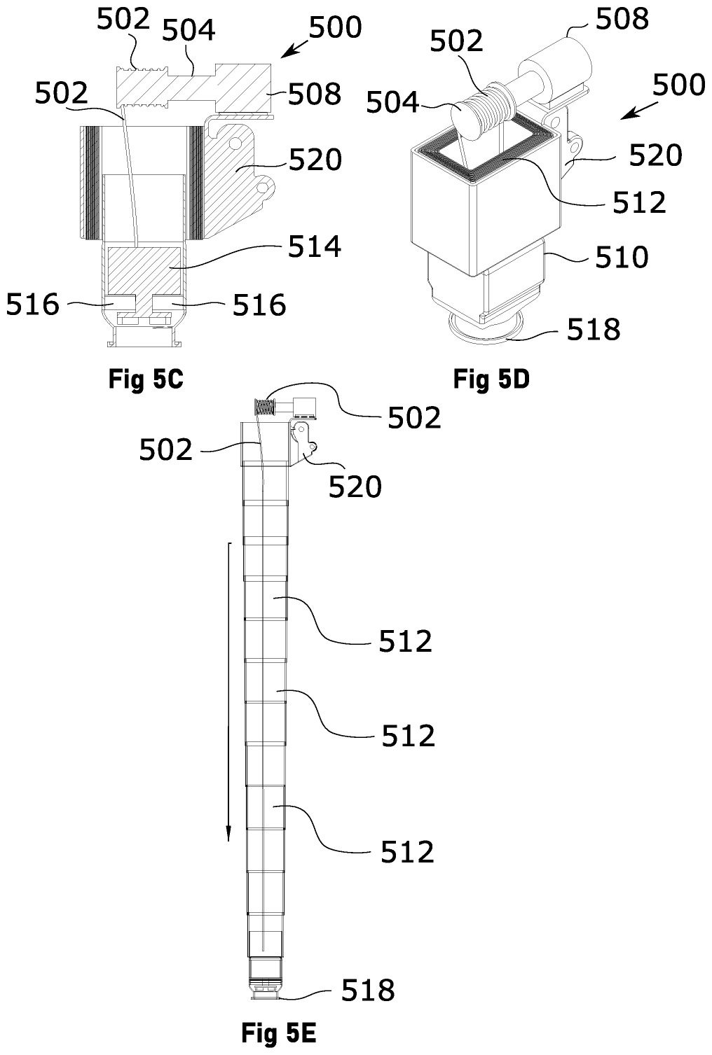

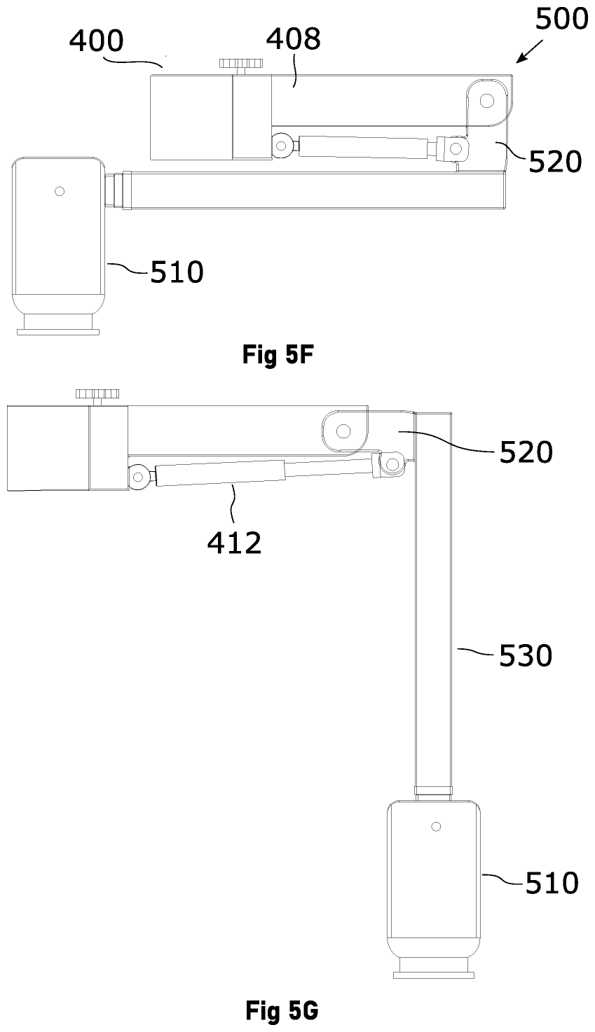

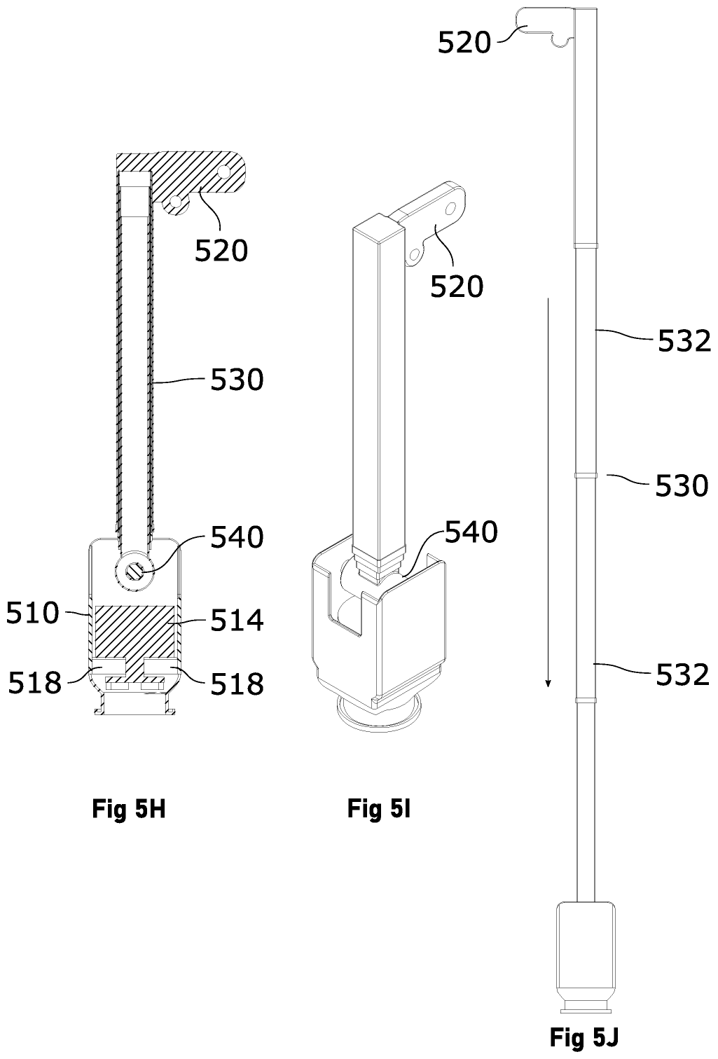

Shock absorbing arm 412 is further configured to mechanically afford, or prevent, the operation of lifting assembly 500, when the latter operates through hydraulic mechanism, as shown in FIGS. 5F and 5G and further discussed below.

Reference is now made to FIGS. 5A-5J which constitute several perspective views and alternatives of a lifting assembly 500, according to some embodiments. Lifting assembly 500 is configured to automatically lower cart 130 to ground level and lift it to elevated level, in a continuous smooth and safe manner. Lifting assembly may operate by any suitable mechanism which can be operated automatically, in a safe manner, while providing passengers in cart 130 a pleasant experience. Optional lifting mechanisms include, but are not limited to, hydraulic mechanisms, scissor lift mechanisms, lifting drum installation, pulley lifting mechanisms, the lifting mechanism disclosed in any one of CN108819957 and U.S. Pat. No. 8,375,865 and combinations thereof. Each possibility is a separate embodiment of the present invention.

In some embodiments, lifting assembly 500 includes a lifting assembly connector 520 through which lifting assembly 500 is attached to rotation arm 408 of rotation assembly 400.

In some embodiments, lifting assembly 500 operates through a pulley lifting mechanism. In some embodiments, lifting assembly 500 includes a cable connected to cart 130, the rolling of which is the mechanism by which cart 130 descend to ground level or elevates to the travel level, as exemplified in FIGS. 5A-5E.

It is to be understood that ground level refers to the lowest level to which cart 130 is reduced, which is close to the sidewalk level, but preferably is a few centimeters above the actual pavement, in order to prevent undesired collision between cart 130 and the pavement/sidewalk. Such collisions may produce undesired tilting of cart 130, excess noise, and hence could interfere and even damage the quality of travel in elevated public transportation system 100 and the quality of the environment surrounding elevated public transportation system 100. In addition, direct contact with a road, a sidewalk and the like, even when performed gently, may damage the bottom part of cart 130 and hence may affect the durability of cart 130. Thus, the term ‘ground level’ as used herein refers to a level that is sufficiently close to the pavement, and sufficiently comfortable as it does not require a particular effort to get on/off cart 130. In some embodiments, ground level is up to 15 cm above the pavement. In some embodiments, ground level is up to 12 cm above the pavement. In some embodiments, ground level is within the range of 5 to 15 cm above the pavement. As explained above, cart 130 may include a ramp (not shown), or passenger seat 136 may include a ramp that opens up when required, thereby enabling wheeled objects, to access cart 130.

[symbol]

The term ‘travel level’ as used herein refers to an elevated position, where cart 130 is safely positioned adjacent to interconnected rails network 110. Travel level may be about of to 12 meters above ground level is within the range.

The term “cable” as used herein refers to any suitable component, such as, a wire or a rope, which is flexible and has the required elasticity allowing it to be rolled around a corresponding shaft in both directions (up and down), and is also sufficiently robust for holding cart 130 safely, and lifting/reducing cart 130 numerous times.

In some embodiments, lifting assembly 500 operates as a traction lift. In some embodiments, lifting assembly 500 includes a cable 502, a pulley 504 and pulley motor 508.

In some embodiments, lifting assembly 500 further includes cable telescopic housing 510, configured to cover cable 502, for forming a rigid structure around cable 502 thereby protecting the cable, and the entire lifting assembly, from undesired movements which may be caused by environmental disturbances, such as, winds, rain, falling leaves, tree branches and birds. Telescopic housing 510 includes a plurality of tubes 512 nested within one another in a folded position and connected to each other when extending and opening up. Tubes 512 are configured to fold up when lifting assembly 500 lifts up cart 130, in concert with the rolling up of cable 502. During travel tubes 512 are completely folded up and remain within nested tube housing 511 (as shown, for example, in FIGS. 5A-5D). Upon reducing cart 130 to ground level, tubes 512 open downward (as shown, for example, in FIG. 5E) in concert with the rolling down of cable 502. In some embodiments, pulley motor 508 is operatively connected to the first/widest tube 512.

In some embodiments, lifting assembly 500 further includes lifting engine 514 operationally linked to cart 130 and configured to maintain cart 130 in a position facing the travel direction, at any time, including when cart 130 rotates, as shown, for example, in FIGS. 4D and 4E (before and after rotation, respectively). In some embodiments, lifting assembly 500 further includes one or more lifting engine supporting plates 516, configured to hold and/or support lifting engine 514.

The terms “operationally linked” or “operationally connected” mean that two or more devices connected by a “linkage” are connected, directly, or indirectly, but in such a fashion that the linked devices operate in the intended fashion. The term “linkage” is used herein to designate any kind of operational link that connects the two or more stated devices in an operational fashion. Linkages may be mechanical linkage, and/or electrical linkage (via wire linkages or wireless linkages) of any configuration.

Lifting assembly 500 further includes attachment mechanism configured to attach lifting assembly 500 to cart 130, preferably, by attaching cart attachment member 518 to the top surface (roof) of cart 130. The attachment mechanism, including cart attachment member 518, may include any component suitable to safely hold cart 130, during traveling along interconnected rail network 110, as well as when lifting or reduced. The attachment mechanism may include, without being limited to, magnets, hooks, latches, flanges and the like. The attachment mechanism is further configured to enable safe disconnection of cart 130 from lifting assemble 500, e.g., for maintenance or replacement an old cart with a new cart.

In some embodiments, lifting assembly 500 includes a hydraulic telescopic cylinder 530, configured to reduce cart 130 to ground level or elevate cart 130 to the travel level, as exemplified in FIGS. 5F-5J.

In some embodiments, hydraulic telescopic cylinder 530 is folded up when lifting assembly 500 lifts up cart 130, and during travel of cart 130 at along interconnected rails network 110. In some embodiments, folded hydraulic telescopic cylinder 530 is further bent such that it is substantially parallel to interconnected rail network 110, as shown in FIG. 5F. However, when folded hydraulic telescopic cylinder 530 is bent, cart 130 remains in its position relative to the ground and to the sky, namely, cart 130 remains facing the travel direction (driving direction), with its bottom facing down (i.e., facing the ground, the sidewalk or the curb) and its top (i.e., cart top surface 134) is facing up (i.e., the sky). Lifting engine 514 within engine capsule 510 is operationally linked to cart 130 and configured to maintain cart 130 facing the travel direction (driving direction). In some embodiments, an additional engine 540 housed within engine capsule 510, is operationally connected to cart 130 and to hydraulic telescopic cylinder 530 and operates to maintain cart 130 in its position and prevent it from tilting aside, when folded hydraulic telescopic cylinder 530 bends up, and also when folded hydraulic telescopic cylinder 530 bends down.

In some embodiments, shock absorbing arm 412 is configured to control the bending up/down movements of folded hydraulic telescopic cylinder 530 by enabling gentle motions only, and preventing abrupt movements. Abrupt movements may risk passengers in car 130. Shock absorbing arm 412 also protects the durability of interconnected rail network 110 and its components, by enabling only controllable movements.

In some embodiments, the controller is for example, a computing system which may include storage, one or more input devices, one or more output devices, and one or more communication connections. An interconnection mechanism (not shown) such as a bus, controller, or network may interconnect the components of the computing system. Typically, operating system software provides an operating environment for other software executing in the computing system and coordinates activities of the components of the computing system. The controller is configured to control all the operations of elevated public transportation system 100, including, all automatic and mechanic operation described herein, such as, progression and halt of cart 130, exchanging between rails through transition rail 118, determining the timing of exchange in view of the status of other carts on elevated public transportation system 100, operating the rotating aside (broad band formation) through operation of rotation assembly 400, determining the timing of rotation in view of the status of other carts on elevated public transportation system 100, operating descending and ascending of cart 130, operating door opening of cart 130. operating driving assembly 300 and its various components, operating rotation assembly 400 and its various components and of cart 130lifting assembly 500 and its various components.

In some embodiments, the controller is further configured to determine the speed of drive of each cart 130 along the rails. Accordingly, carts 130 arrive to their destination (for picking up or dropping off) smoothly, with minimum to null delays and slowdown. Thus, the controller enables to determine with high accuracy time of arrival to destination of each cart 130.

In some embodiments, elevated transportation system 100 further comprises a surveillance system (not shown), configured to continuously monitor the activities of elevated transportation system 100. The surveillance system comprises a plurality of cameras adapted to continuously acquire images and videos. In some embodiments, the surveillance system is associated with an alert system, and with the controller, such that, any passenger or freight intending to enter the system, without permission (not ordered in advance, identity of passenger/freight unapproved) prompts an alert, prevents opening of cart 130, and, optionally, contacts the authorities. Thus, the surveillance system is configured to prevent damages to the public, such as, prevent terror attacks, and may be useful for preventing the spread epidemics, through careful monitoring, and hence adds an additional layer of safety to elevated transportation system 100.

The controller is also configured to control any interaction between passengers, potential passengers and elevated public transportation system 100, including, but not limited to, ordering a ride, concluding a ride, interaction with an application associated with elevated public transportation system 100 installed on personal devices (such as, personal computers, tablets and smart phones) and interaction with the user interface installed in cart 130.

The controller is also configured to control all safety and security mechanisms associated with the operation of elevated public transportation system 100.

In the description and claims of the application, the words “include” and “have”, and forms thereof, are not limited to members in a list with which the words may be associated. These words refer to open terminology, as opposed to ‘consisting of’ which is limiting to members in a list.

One skilled in the art readily appreciates that the present invention is well adapted to carry out the objects and obtain the ends and advantages mentioned, as well as those inherent therein. The examples provided herein are representative of preferred embodiments, are exemplary, and are not intended as limitations on the scope of the invention.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

Unless specifically stated otherwise, as apparent from the disclosure, it is appreciated that, according to some embodiments, terms such as “processing”, “computing”, “calculating”, “determining”, “estimating”, “assessing”, “gauging” or the like, may refer to the action and/or processes of a computer or computing system, or similar electronic computing device, that manipulate and/or transform data, represented as physical (e.g. electronic) quantities within the computing system's registers and/or memories, into other data similarly represented as physical quantities within the computing system's memories, registers or other such information storage, transmission or display devices.

Embodiments of the present disclosure may include apparatuses for performing the operations herein. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method(s). The desired structure(s) for a variety of these systems appear from the description below. In addition, embodiments of the present disclosure are not described with reference to any particular programming language. It will be appreciated that a variety of programming languages may be used to implement the teachings of the present disclosure as described herein.

Aspects of the disclosure may be described in the general context of computer-executable instructions, such as program modules, being executed by a computer. Generally, program modules include routines, programs, objects, components, data structures, and so forth, which perform particular tasks or implement particular abstract data types. Disclosed embodiments may also be practiced in distributed computing environments where tasks are performed by remote processing devices that are linked through a communications network. In a distributed computing environment, program modules may be located in both local and remote computer storage media including memory storage devices.

1. An elevated public transportation system comprising:
(a) at least one interconnected rails network configured to transport carts in a travel direction there along, having a plurality of rails aligned with one another, wherein the plurality of rails comprising (i) an external sidewalk rail positioned at the periphery of the at least one interconnected rails network in proximity to a sidewalk, configured for picking up and dropping off passengers and/or freight, (ii) at least one additional rail, and (iii) at least one transition rail extended between the external sidewalk rail and the at least one additional rail, configured to enable transition of a cart therebetween;
(b) at least one rotation assembly associated with the at least one interconnected rails network and configured to rotate a cart suspended from any of the rails in an angle; and
(c) a plurality of support posts configured to hold said at least one interconnected rails network above ground level.

2. The elevated public transportation system of claim 1, further comprising at least one controller configured to control the operation of the elevated public transportation system and at least one power source configured to supply electricity to the elevated public transportation system.

3. The elevated public transportation system of claim 2, further comprising at least one lifting assembly configured to hold, suspended therefrom, the cart, by extending between the cart and the at least one rotation assembly, wherein the lifting assembly is configured to lower down to ground level, and elevate to elevated level, the cart.

4. The elevated public transportation system of claim 3, further comprising a plurality of carts, wherein each cart is configured to suspend from said plurality of rails of the at least one interconnected rails network through the at least one lifting assembly extending between said cart and the at least one rotation assembly, wherein the lifting assembly is configured to lower down to ground level, and elevate to elevated level, said each cart of the plurality of carts.

5. The elevated public transportation system of claim 1, wherein said elevated public transportation system is not associated with predetermined drop off or pick up locations.

6. The elevated public transportation system of claim 1, comprising a plurality of interconnected rails networks.

7. The elevated public transportation system of claim 6, wherein the plurality of interconnected rails networks comprises two interconnected rail networks, wherein one of the two interconnected rail network is configured to travel in the travel direction and the other interconnected rail network is configured to travel in a direction other than the travel direction.

8. The elevated public transportation system of claim 1, wherein the at least one additional rail is an external road rail aligned with external sidewalk rail, positioned farther way from the sidewalk.

9. The elevated public transportation system of claim 4, wherein said each cart comprising at least one door facing the sidewalk.

10. The elevated public transportation system according to claim 1, wherein each of the plurality of the support posts is arched, having one end pivoted in the ground and another end holding the plurality of interconnected rails elevated above ground level.

11. The elevated public transportation system of claim 8, further comprising at least one internal rail positioned between the external sidewalk rail and the external road rail.

12. The elevated public transportation system according to claim 3, wherein the at least one controller controls the operation of the lifting assembly and the rotation assembly, based on (i) predetermined commands; (ii) real time commands received from passengers and potential passengers, wherein the commands comprise pick up locations and drop off destinations.

13. The elevated public transportation system according to claim 3, further comprising a driving assembly extending between the lifting assembly and the rail from which the cart suspends, wherein the driving assembly comprises a plurality of wheels and engines configured to drive said cart along said rail, automatically.

14. The elevated public transportation system of claim 1, further comprising a rail housing configured to cover the interconnected rails network.

15. The elevated public transportation system of claim 14, further comprising a plurality of solar panels, configured to provide power to said power source.

16. The elevated public transportation system of claim 4, wherein each cart further associates with an engine configured to maintain the cart in a position facing the travel direction, when said rotation assembly rotates the cart in said angle.

17. The elevated public transportation system of claim 7, further comprising at least one junction, wherein at least two interconnected rail networks cross one another at the at least one junction.

18. The elevated public transportation system of claim 17, wherein the at least one junction comprises at least one circular rail.
